(19) United States
(12) Patent Application Publication
(10) Pub. No.: US 2007/0283149 A1
(43) Pub. Date: Dec. 6, 2007

(54) Home address auto-configuration during use of a mobile protocol authentication option protocol

(75) Inventor: Vijay Devarapalli, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/442,166

(22) Filed: May 30, 2006

(51) Int. Cl. H04L 9/00

(52) U.S. Cl. 713/168

(57) ABSTRACT

A method for auto-configuring a home address by a mobile node, the method includes transmitting an update message from a mobile node to a home agent. The update message includes at least a nonce and an option for requesting a home prefix from the home agent. The method further includes processing the update message, by the home agent, and transmitting a home prefix message with the home prefix, from the home agent to the mobile node. The home prefix message is protected by a configuration key derived from the nonce. The method also includes deriving, by the mobile node, a home address from the home prefix and transmitting the home address to the home agent for verification of the uniqueness of the home address and sending an acknowledgement message, from the home agent to the mobile, upon successful verification of the uniqueness of the home address.

### BACKGROUND OF THE INVENTION

1. Field of the Invention

The present invention relates to how a mobile node can auto-configure its home address, and more particularly, to how a mobile node using the Mobile Internet Protocol (IP) can auto-configure its home address when using the mobile IP authentication option protocol.

2. Description of the Related Art

Mobile IPv6 is a mobility protocol for IPv6, wherein the protocol maintains a mobile node's sessions even when the mobile node moves and changes its Internet Protocol (IP) address. Mobile IPv6 protocol is an example of a mobility protocol that requires that the mobile node knows its home agent address, its own home address and the cryptographic materials needed to set up IPsec security associations with its home agent, before it can start using mobile IPv6 services, in order to protect mobile IPv6 signalling. This requirement is generally referred to as the mobile IPv6 “bootstrapping” problem. However, the mobile IPv6 base protocol does not specify any method for automatically acquiring the information needed to solve the bootstrapping problem. Some or all of the home agent address, a home address and IPsec security associations may be statically configured. This means that network administrators are typically required to manually set configuration data on mobile nodes and home agents. However, this solution is impractical as manual configuration does not scale well as the number of mobile nodes increase.

There are current efforts on solving the bootstrapping problem associated with mobile IPv6 in order to dynamically assign the home address and home agent address for the mobile node. Because dynamically bootstrapping the mobile node's home address is very critical for mobile IPv6 deployment, there are specific mechanisms proposed, for example, in the Internet Engineering Task Force (IETF), to dynamically configure the mobile node with its home address. However, the mechanisms disclosed by the IETF are based on the use of IKEv2. Furthermore, none of the other current bootstrapping mechanisms address bootstrapping when the authentication option protocol is used.

The mobile node may also auto-configure its home address once the mobile node knows its home prefix. Prior 3GPP2 specifications specified a mechanism to convey the home prefix to the mobile node when it undergoes access authentication. The mobile node then auto-configures the home address and sends a binding update message with the configured home address. This approach, however, requires support in a visited network for mobile IPv6 bootstrapping and is not a generic solution that will work in all deployments.

### SUMMARY OF THE INVENTION

An embodiment of the invention relates to a method for auto-configuring a home address by a mobile node, the method including transmitting an update message from a mobile node to a home agent. The update message includes at least a nonce and an option for requesting a home prefix from the home agent. A nonce in an embodiment of the invention is a randomly generated number. The method further includes processing the update message by the home agent, and transmitting a home prefix message with the home prefix from the home agent to the mobile node. The home prefix message is protected by a configuration key derived from the nonce. The method also includes deriving, by the mobile node, a home address from the home prefix and transmitting the home address to the home agent for verification of the uniqueness of the home address and sending an acknowledgement message, from the home agent to the mobile, upon successful verification of the uniqueness of the home address.

Another embodiment of the invention is directed to a mobile node for auto-configuring a home address, the mobile node including a generating unit for generating an update message and transmitting the update message to a home agent. The update message includes at least a nonce and an option for requesting a home prefix from the home agent. The home agent processes the update message and transmits a home prefix message with the home prefix to the mobile node. The home prefix message is protected by a configuration key derived from the nonce. The mobile node also includes a processing unit for deriving a home address from the home prefix, for transmitting the home address to the home agent for verification of the uniqueness of the home address and for receiving an acknowledgement message, from the home agent, upon successful verification.

Another embodiment of the invention is directed to a home agent that provides a home prefix for auto-configuring a home address by a mobile node. The home agent includes a receiving unit for receiving an update message from a mobile node. The update message includes at least a nonce and an option for requesting a home prefix from the home agent. The home agent also includes a processing unit for processing the update message and transmitting a home prefix message with the home prefix to the mobile node. The home prefix message is protected by a configuration key derived from the nonce. The mobile node derives a home address from the home prefix and transmits the home address to the home agent for verification of the uniqueness of the home address. The home agent further includes a transmitting unit for transmitting an acknowledgement message to the mobile, upon successful verification of the home address.

Yet another embodiment of the invention is directed to an apparatus that includes transmitting means for transmitting an update message from a mobile node to a home agent. The update message includes at least a nonce and an option for requesting a home prefix from the home agent. The apparatus also includes processing means for processing the update message, by the home agent, and transmitting a home prefix message with the home prefix, from the home agent to the mobile node, the home prefix message being protected by a configuration key derived from the nonce. The apparatus further includes deriving means for deriving, by the mobile node, a home address from the home prefix and transmitting the home address to the home agent for verification of the uniqueness of the home address and sending means for sending an acknowledgement message, from the home agent to the mobile, upon successful verification.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of a system for implementing home address auto-reconfiguration, by a mobile node, with mobile IPv6 authentication option protocol;

FIG. 1b illustrates the message flow implemented in an embodiment of the invention;

FIG. 2 illustrates the steps implemented in an embodiment of the invention;

FIG. 3 illustrates the Home Prefix Request mobility option that is transmitted from the mobile node to the home agent in the binding update message;

FIG. 4 illustrates the currently defined mobility header message format used an embodiment of the invention;

FIG. 5 illustrates the Home Prefix mobility header message generated by the home agent and transmitted to the mobile node, in an embodiment of the invention; and

FIG. 6 illustrates the Auto-configured Home Address mobility header message generated by the mobile node in response to information obtained from the Home Prefix Message.

### DETAILED DESCRIPTION OF PREFERRED EMBODIMENTS

Reference will now be made to the preferred embodiments of the present invention, examples of which are illustrated in the accompanying drawings.

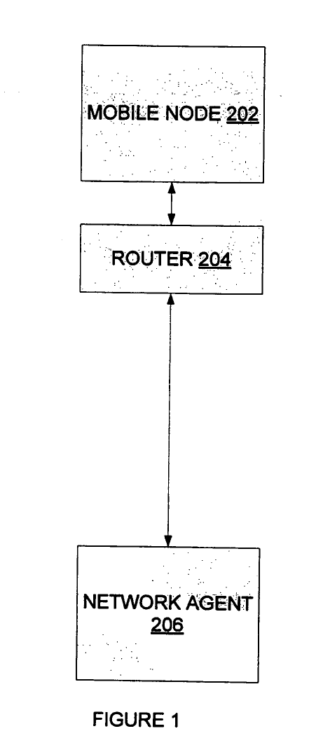

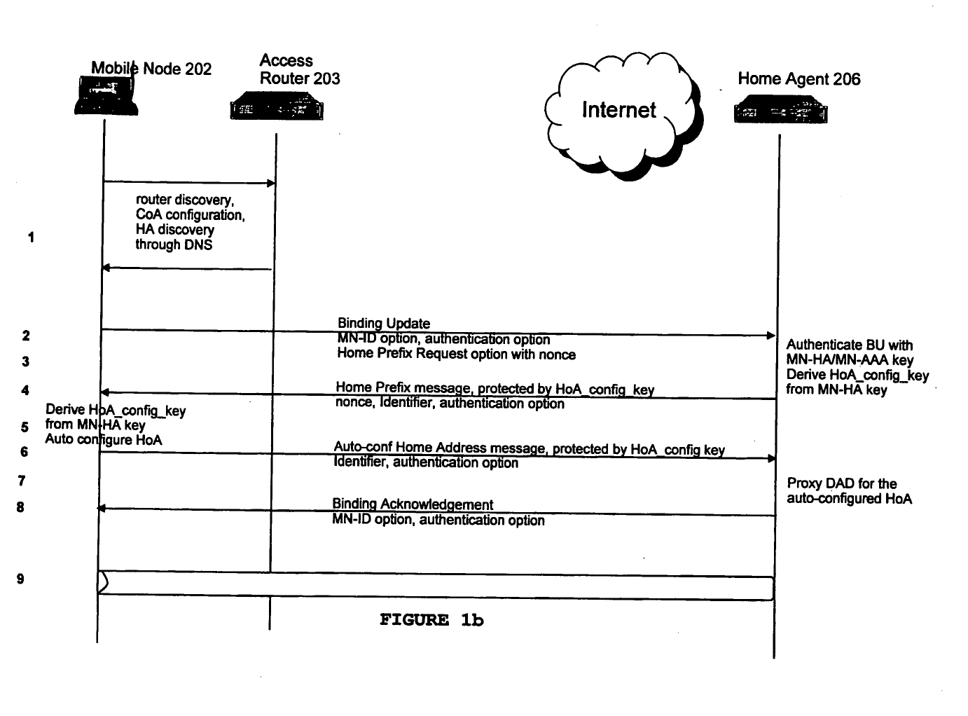

FIG. 1 illustrates an embodiment of a system for implementing home address auto-configuration with mobile IPv6 authentication option protocol. When a mobile node 202 connects to an access network, it first authenticates itself to the access network, configures a default router 204 and a care-of address. Mobile node 202 further discovers a home agent 206 address using currently defined mechanisms, for example by using Domain Name Service (DNS). In one embodiment, for the purpose of performing mobile IPv6 bootstrapping, mobile node 202 queries a DNS server to request information on home agent 206 service. In this embodiment, the only information that needs to be pre-configured on mobile node 202 is the domain name of a mobility service provider. As is known to one skilled in the art, mobile node 202 needs to obtain the IP address of the DNS server before it can send a DNS request. Thus, this information may be pre-configured on mobile node 202 or obtained through other means. For discovering home agent 206, mobile node 202 may also use other predefined mechanisms.

Furthermore, when mobile node 202 is on a foreign link and does not have an assigned home address, mobile node 202 needs to bootstrap its home address. Thus, in an embodiment of the invention, mobile node 202 sends a binding update message that is protected by mobile IPv6 authentication option protocol. The binding update message includes a new mobility option, “Home Prefix Request”, to request a home prefix. Because the home address is not yet known to mobile node 202, the home address field in the home address option is set to 0::0. Mobile node includes a randomly generated 64 bit nonce in the Home Prefix Request. The nonce is a random number that is used to derive a key that can be used to protect home address configuration messages transmitted between mobile node 202 and home agent 206.

Thereafter, when home agent 206 receives the binding update message, it authenticates the binding update message and processes the Home Prefix Request option. Home agent 206 uses the nonce to derive a home agent configuration key (HoA-config-key) from a mobility node-home agent (MN-HA) key. Home agent 206 then sends a new mobility header message, “Home Prefix Message”, protected by the HoA-config-key to mobile node 202. The Home Prefix Message includes the home prefix requested by mobile node 202 in the binding update message. Home agent 206 further includes a 16 bit identifier in Home Prefix Message, to later match the response of mobile node 202 to the home agent's Home Prefix Message containing the home prefix.

When mobile node 202 receives the home prefix, it first derives the HoA-config-key, authenticates the Home Prefix Message and then auto-configures its home address from the home prefix. For auto-configuration of the home address, mobile node 202 may use stateless IPv6 address auto-configuration, privacy extensions or cryptographically generated addresses. Once the home address is configured, mobile node 202 sends the configured home address to home agent 206 to inform home agent 206 of the newly auto-configured home address. The home address is sent in a new mobility header message, “Auto-configured Home Address” message, which is also protected by the HoA-config-key. Once home agent 206 receives the home address of mobile node 202, it authenticates the message and then runs the proxy duplicate address detection mechanism to verify that the newly received home address is unique. If the proxy duplicate address detection succeeds, i.e., the newly auto-configured home address is unique, home agent 206 sends a binding acknowledgement as a response to the initial binding update. Once mobile node 202 receives the binding acknowledgement, mobile node 202 and the home agent setup a mobile IP tunnel

FIG. 1b illustrates the message flow implemented in an embodiment of the present invention. Specifically, FIG. 1b illustrates message flow from mobile node 202 to home agent 206 through access router 203 and the Internet. Mobile node 202 performs router discovery, care-of address and discovers home agent 206 address through access router 203. Then mobile node 202 sends a binding update message to home agent 206. The binding update message includes the Home Prefix Request option with the nonce, the mobile node ID option and the authentication option. Home agent 206 returns a Home Prefix Message that is protected by the HoA-config-key, the nonce, the identifier, and an authentication option, to mobile node 202. Mobile node 202 derives the HoA-config-key from the mobility node-home agent key. Mobile node 202 then sends the auto configured home address message to home agent 206, wherein the auto configured home address is protected by the HoA-config-key, the identifier and the authentication option. Home agent 206 runs the proxy duplicate address detection mechanism for the auto-configured home address. Home agent 206 then sends a binding acknowledgement that includes the mobile node ID option and the authentication option, to the mobile node.

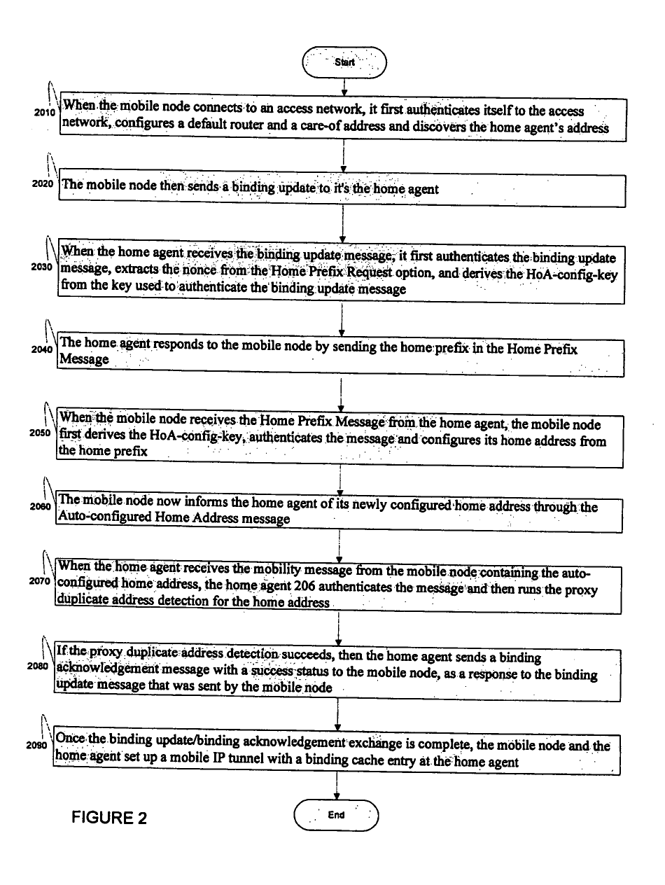

FIG. 2 illustrates the steps implemented in an embodiment of the invention. In Step 2010, when the mobile node connects to an access network, it first authenticates itself to the access network, configures a default router and a care-of address and discovers the home agent's address. In Step 2020, mobile node 202 then sends a binding update to its home agent 206. If mobile nodes 202 wants to configure a home address and it does not know the home prefix, mobile node 202 requests for the home prefix by including a Home Prefix Request option in the binding update message, wherein the Home Prefix Request option includes a randomly generated 64 bit nonce that is used in HoA-config-key derivation. The binding update message also includes a mobile node identifier (MN-ID) option and an authentication option. In an embodiment of the invention, mobile node 202 must use a larger timeout for the binding update message, taking into account the additional exchange that is required for the home address auto-configuration. The timeout is configurable on mobile node 202. In Step 2030, when home agent 206 receives the binding update message, it first authenticates the binding update message. Upon determining a request for the home prefix, home agent 206 extracts the nonce from the Home Prefix Request option and derives the HoA-config-key from the key used to authenticate the binding update message. In an embodiment, the HoA-config-key is derived from a keyed-hashing for message authentication. Specifically, the HoA-config-key is derived from HMAC_SHA1(MN-HA key, {nonce|MN identifier}) where the MN-HA key is used to protect the binding update message and the MN identifier is the identity the mobile node uses, for example a fully qualified domain name (FQDN).

In Step 2040, home agent 206 then responds to mobile node 202 by sending the home prefix in the Home Prefix Message. This message is protected by HoA-config-key with the authenticator calculated as: Authenticator=First (96, HMAC_SHA1(HoA-config-key, message data)); message data=home prefix|mobility header data, wherein the “First” function truncates the output of the result of the HMAC_SHA1 function to the first 96 bits and mobility header data includes the contents of the message starting from the first byte of the mobility header payload protocol to end of the message. Home agent 206 also includes an identifier in the message to match the response from mobile node 202 when mobile node 202 sends the auto-configured home address to home agent 206. In Step 2050, when mobile node 202 receives the Home Prefix Message from home agent 206, mobile node 202 first derives the HoA-config-key, authenticates the message and configures its home address from the home prefix. For configuring the home address, mobile node 202 may use stateless IPv6 address auto-configuration, privacy extensions or cryptographically generated addresses. As is known to those skilled in the art, other mechanisms may also be used for auto-configuring the home address by mobile node 202.

In Step 2060, mobile node 202 now informs home agent 206 of its newly configured home address through the Auto-configured Home Address message. The message is also protected by the HoA-config-key with the authenticator calculated as: Authenticator=First (96, HMAC_SHA1(HoA-config-key, message data)), Message data=home prefix|home address|mobility header data, wherein the “First” function truncates the output of the result of the HMAC_SHA1 function to the first 96 bits and mobility header data includes the contents of the message starting from the first byte of the mobility header payload protocol to end of the message. In Step 2070, when home agent 206 receives the mobility message from mobile node 202 containing the auto-configured home address, home agent 206 authenticates the message and then runs the proxy duplicate address detection for the home address. The proxy duplication address detection is used to verify that the home address is unique and not previously configured by another node. In Step 2080, if the proxy duplicate address detection succeeds, then home agent 206 sends a binding acknowledgement message with a success status to mobile node 202, as a response to the binding update message that was sent by mobile node 202 in step 2020. In Step 2090, once the binding update/binding acknowledgement exchange is complete, mobile node 202 and home agent 206 set up a mobile IP tunnel with a binding cache entry at home agent 206.

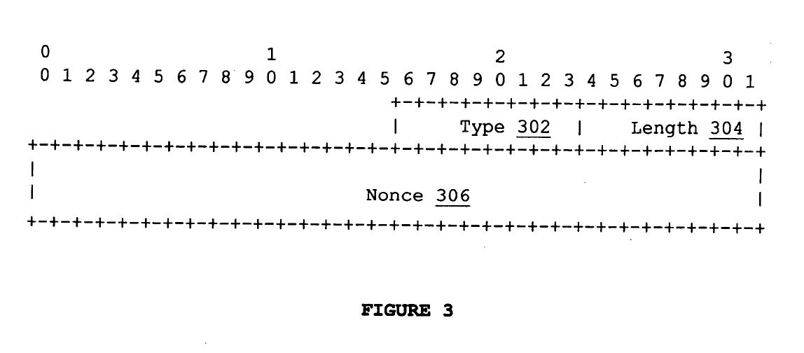

FIG. 3 illustrates the Home Prefix Request mobility option that is transmitted from mobile node 202 to home agent 206 in the binding update message. The Home Prefix Request mobility option includes a type field 302, a length field 304 and a Nonce field 306. Type field 302 is used for indicating the type of mobility option; specifically, type field 302 is used for indicating the Home Prefix Request mobility option. In an embodiment, type field 302 is an eight bit integer. Length field 304 is the length of the Home Prefix Request option in bytes, excluding type field 302 and length field 304. Nonce 306 is a randomly generated field, by mobile node 202. In an embodiment of the invention, nonce 306 is 64 bits in length.

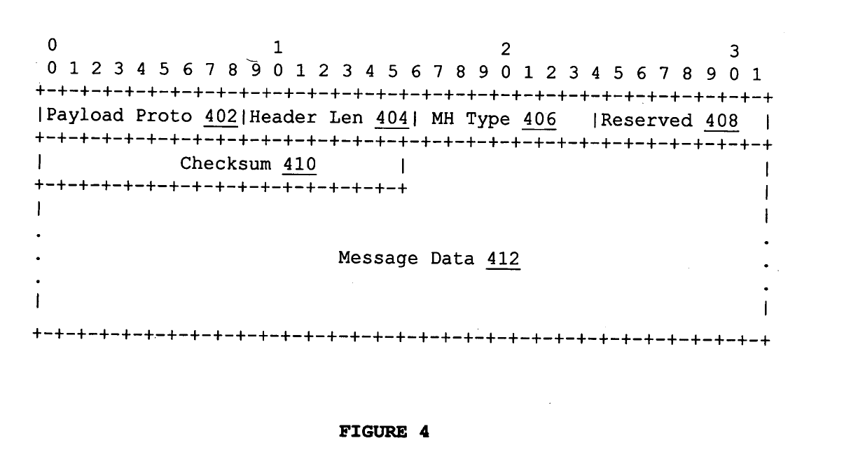

FIG. 4 illustrates the currently defined mobility header message format used an embodiment of the invention. The mobility header message format includes a payload proto field 402, a header length field 404, a mobility header type 406, a reserved field 408, a checksum field 410, and a message data field 412. Payload proto field 402 is an 8-bit selector that identifies the type of header immediately following the Mobility Header. Header length field 404 is a 8-bit unsigned integer, representing the length of the Mobility Header in units of 8 octets, excluding the first 8 octets. The length of the Mobility Header must be a multiple of 8 octets. Mobility header type 406 is an 8-bit selector that identifies the particular mobility message in question. Reserved field 408 is an 8-bit field that is reserved for future use. Checksum field 410 is a 16-bit unsigned integer that includes the checksum of the Mobility Header. The checksum is calculated from the octet string consisting of a “pseudo-header” followed by the entire Mobility Header starting with the Payload Proto field. The checksum is the 16-bit one's complement of the one's complement sum of this string. Message data field 412 is a variable length field containing the data specific to the indicated Mobility Header type. Mobile IPv6 also defines a number of “mobility options” for use within these messages; if included, any options must appear after the fixed portion of message data 412. The presence of such options will be indicated by the Header Len field within the message. When the Header Len value is greater than the length required for the message specified here, the remaining octets are interpreted as mobility options. These options include padding options that can be used to ensure that other options are aligned properly, and that the total length of the message is divisible by 8.

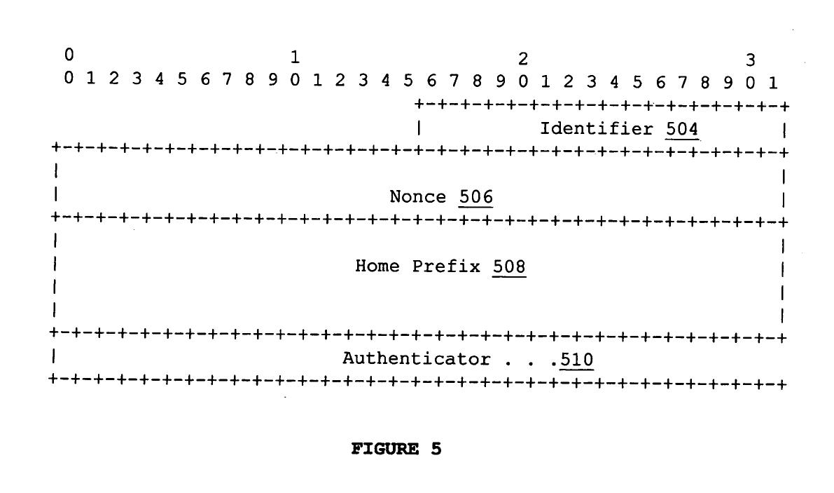

FIG. 5 illustrates the Home Prefix mobility header message generated by home agent 206 and transmitted to mobile node 202 in an embodiment of the invention. The Home Prefix mobility header message includes an identifier 504, a Nonce field 506, a home prefix 508 and an authenticator 510. Identifier 504 is an identifier to match a request from home agent 206 to a response by mobile node 202. In an embodiment, identifier 504 is 16 bits. Nonce 506 is a randomly generated field by mobile node 202, in the earlier step. Home prefix mobility header message is used to carry the IPv6 home prefix 508. In an embodiment, home prefix 508 is a 128 bit field. Authenticator 510 is a variable length field for carrying the authentication data that is used to protect the message.

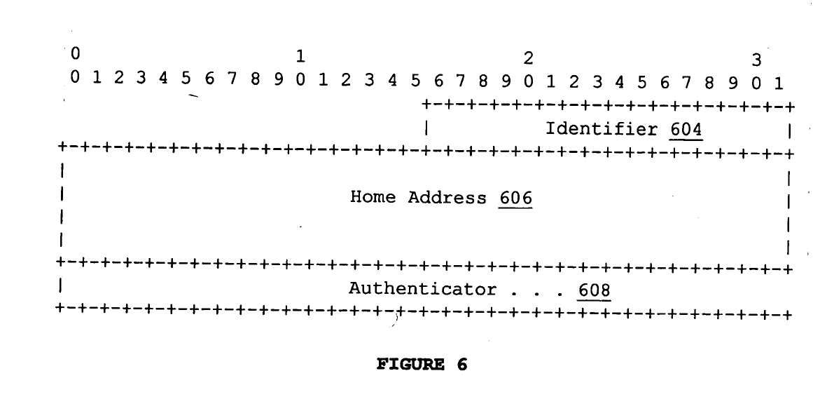

FIG. 6 illustrates the Auto-configured Home Address mobility header message generated by mobile node in response to information obtained from the Home Prefix Message. The Auto-configured Home Address Mobility header message includes an identifier 604, the home address field 606, and an authenticator 608. Identifier 604 is an identifier to match a request from home agent 206 to a response by mobile node 202. Specifically, identifiers 604 and 504 are used to match Home Prefix mobility header message form home agent 206 with Auto-configured Home Address mobility header message from mobile node 202. In an embodiment identifier 604 is 16 bits. Home address field 606 is a 128 bit home address that the mobile node derived. Authenticator 610 is a variable length field for carrying the authentication data that is used to protect the message.

In another embodiment of the invention, instead of using Home Prefix message, as illustrated in FIG. 5, and Auto-configured Home Address message, as illustrated in FIG. 6, binding update and binding acknowledgement messages are reused. In this case, when home agent 206 processes the binding update with a request for home prefix, home agent 206 sends a binding acknowledgement with a special status and a mobility option to carry the home prefix. This binding acknowledgement is sent instead of the Home Prefix message, as disclosed in step 2040 above. Home agent 206 does not yet create a binding cache entry for mobile node 202. Mobile node 202 then auto-configures a home address from the home prefix and sends a binding update again with the newly configured home address to home agent 206. The binding update is sent instead of the Auto-configured Home Address message, as disclosed in step 2060 above. The use of binding update and binding acknowledgement messages instead of the new Home Prefix message, and Auto-configured Home Address message requires modifications to the semantics of the binding update and binding acknowledgement messages. Irrespective of which messages are used, the mechanisms to auto-configure the home addresses are the same.

In another embodiment of the invention, instead of deriving HoA-config-key, the same key that is used for securing the binding updates and binding acknowledgements may be used. However, it may be preferable to use a one time key for home address configuration derived from the MN-HA key, making use of the nonce generated by the mobile node. In an embodiment, the identifier field in Home Prefix message and Auto-configured Home Address message can also be avoided by including the MN-ID option in these messages. The MN-ID option can match the response from the mobile node to the home prefix sent by home agent 206. However, including an MN-ID option increases the packet overhead since a separate mobility option needs to be included in these messages. The 16 bit identifier field, used in an embodiment of the invention therefore, results in lot less overhead. The authenticator field in home prefix message and auto-configured home address message can also be avoided, in the embodiment using only the binding update and acknowledgement message, by using the authentication option that is normally used in protecting the binding update messages. But again the use of this mobility option results in a huge overhead compared to just including the authenticator field in the Home Prefix message and Auto-configured Home Address message.

It should be appreciated by one skilled in art, that the present invention may be utilized in any device that implements the network availability information described above. The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method for auto-configuring a home address by a mobile node, the method comprising:
transmitting an update message from a mobile node to a home agent, the update message comprising at least a random number and an option for requesting a home prefix from the home agent;
processing the update message, by the home agent, and transmitting a home prefix message with the home prefix, from the home agent to the mobile node, the home prefix message being protected by a configuration key derived from the random number;
deriving, by the mobile node, a home address from the home prefix and transmitting the home address to the home agent for verification of the uniqueness of the home address; and
sending an acknowledgement message, from the home agent to the mobile, upon successful verification.

2. The method of claim 1, wherein the step of transmitting the update message comprises sending the update message that is protected by mobile IPv6 authentication option protocol, the update message comprising a mobile node identifier and an authentication option.

3. The method of claim 1, wherein the step of transmitting the update message comprises sending the update message wherein a home address field is set to 0::0.

4. The method of claim 1, wherein the step of processing the update message comprises authenticating the update message, processing the option for requesting the home prefix and using the random number to derive the configuration key.

5. The method of claim 1, wherein the step of using the random number to derive the configuration key comprises deriving the configuration key from a keyed-hashing for message authentication.

6. The method of claim 1, wherein the step of processing the update message comprises including an identifier in the home prefix message for matching a response from the mobile node to the home prefix message.

7. The method of claim 1, wherein the step of deriving the home address comprises deriving the configuration key, authenticating the home prefix message and auto-configuring the home address from the home prefix.

8. The method of claim 1, wherein the step of transmitting the home address to the home agent comprises transmitting the home address in an auto-configured home address message that is protected by the configuration key.

9. The method of claim 8, further comprising the step of authenticating the auto-configured home address message and executing a proxy duplicate address detection to verify the uniqueness of the home address.

10. The method of claim 1, further comprising setting up a mobile IP tunnel between the home agent and the mobile node.

11. A mobile node for auto-configuring a home address, the mobile node comprising:
a generating unit for generating an update message and transmitting the update message to a home agent, the update message comprising at least a random number and an option for requesting a home prefix from the home agent, wherein the home agent processes the update message and transmits a home prefix message with the home prefix to the mobile node, the home prefix message being protected by a configuration key derived from the random number; and
a processing unit for deriving a home address from the home prefix, for transmitting the home address to the home agent for verification of the uniqueness of the home address and for receiving an acknowledgement message, from the home agent, upon successful verification.

12. The mobile node of claim 11, wherein the generating unit is configured to send the update message that is protected by mobile IPv6 authentication option protocol, the update message comprising a mobile node identifier and an authentication option.

13. The mobile node of claim 11, wherein the generating unit is configured to transmit the update message, wherein a home address field is set to 0::0.

14. The mobile node of claim 11, wherein the processing unit is configured to derive the configuration key, authenticate the home prefix message and auto-configure the home address from the home prefix.

15. The mobile node of claim 11, wherein the processing unit is configured to transmit the home address in an auto-configured home address message that is protected by the configuration key.

16. The mobile node of claim 11, wherein the mobile node is configured to set up a mobile IP tunnel with the home agent.

17. A home agent for providing a home prefix for auto-configuring a home address by a mobile node, the home agent comprising:
a receiving unit for receiving an update message from a mobile node, the update message comprising at least a random number and an option for requesting a home prefix from the home agent;
a processing unit for processing the update message and transmitting a home prefix message with the home prefix to the mobile node, the home prefix message being protected by a configuration key derived from the random number, wherein the mobile node derives a home address from the home prefix and transmits the home address to the home agent for verification of the uniqueness of the home address; and
a transmitting unit for transmitting an acknowledgement message to the mobile, upon successful verification of the home address.

18. The home agent of claim 17, wherein the processing unit is configured to authenticate the update message, process the option for requesting the home prefix and use the random number to derive the configuration key.

19. The home agent of claim 17, wherein the processing unit is configured to derive the configuration key from a keyed-hashing for message authentication.

20. The home agent of claim 17, wherein the processing unit is configured to include an identifier in the home prefix message for matching a response from the mobile node to the home prefix message.

21. The home agent of claim 17, wherein the processing unit is configured to authenticating the auto-configured home address message and execute a proxy duplicate address detection to verify the uniqueness of the home address.

22. The home agent of claim 17, wherein the home agent is configured to set up a mobile IP tunnel between the home agent and the mobile node.

23. An apparatus comprising:
transmitting means for transmitting an update message from a mobile node to a home agent, the update message comprising at least a random number and an option for requesting a home prefix from the home agent;
processing means for processing the update message, by the home agent, and transmitting a home prefix message with the home prefix, from the home agent to the mobile node, the home prefix message being protected by a configuration key derived from the random number;
deriving means for deriving, by the mobile node, a home address from the home prefix and transmitting the home address to the home agent for verification of the uniqueness of the home address; and
sending means for sending an acknowledgement message, from the home agent to the mobile, upon successful verification.
